(19) United States
(12) Patent Application Publication
(10) Pub. No.: US 2018/0158244 A1
(43) Pub. Date: Jun. 7, 2018

(54) VIRTUAL SENSOR CONFIGURATION

(71) Applicant: Ayotle, Paris (FR)

(72) Inventors: José Alonso Ybanez Zepeda, Paris (FR); Gisèle Belliot, Paris (FR)

(73) Assignee: Ayotle, Paris (FR)

(21) Appl. No.: 15/368,006

(22) Filed: Dec. 2, 2016

(51) Int. Cl. G06T 19/00; G06T 7/00; G06F 3/01

(52) U.S. Cl. CPC G06T 19/006; G06T 7/0044; G06T 2207/30196; G06T 19/003; G06T 2207/10028; G06F 3/017

(57) ABSTRACT

A method for configuring a virtual sensor in a real scene, the method comprising: obtaining at least one first three dimensional (3D) representation of the real scene, analyzing said at least one first 3D representation to detect a beacon in the real scene and computing from said at least one first 3D representation a position of the beacon in the real scene; generating virtual sensor configuration data for the virtual sensor on the basis at least of the position of the beacon, the virtual sensor configuration data representing a volume area having a predefined positioning with respect to the beacon, at least one virtual sensor trigger condition associated with the volume area, and at least one operation to be triggered when said at least one virtual sensor trigger condition is fulfilled.

### BACKGROUND

The subject disclosure relates to the field of human-machine interface technologies.

The patent document WO2014/108729A2 discloses a method for detecting activation of a virtual sensor. The virtual sensor is defined by means of a volume area and at least one trigger condition. The definition and configuration of the volume area relies on a graphical display of a 3D representation of the captured scene 151 in which the user has to navigate so as to define graphically a position and a geometric form defining the volume area of the virtual sensor with respect to the captured scene 151.

The visual understanding of the 3D representation and the navigation in the 3D representation may not be easy for users that are not familiar with 3D representations like 3D images.

In addition, in order to configure the virtual sensor it is necessary to provide a computer configured to display 3D representation of the captured scene 151 and to navigate in the 3D representation by means of a 3D engine. Further, the display screen have to be large enough to be able to display the complete 3D representation in a comprehensive manner and to be able to navigate in 3D representation with a clear view on the positions of the objects in the scene with respect to which the volume area of the virtual sensor has to be defined. It is therefore desirable to simplify the configuration process and/or to reduce the necessary resources.

### SUMMARY

It is an object of the present subject disclosure to provide systems and methods for configuring a virtual sensor in a real scene.

According to a first aspect, the present disclosure relates to a method for configuring a virtual sensor in a real scene. The method comprises: obtaining a first three dimensional (3D) representation of the real scene, wherein said at least one first 3D representation comprises points representing objects in the real scene and respective associated positions in the real scene; analyzing said at least one first 3D representation to detect a beacon in the real scene, and computing a position of the beacon in the real scene from at least one position associated to a least one point of a set of points representing the beacon in said at least one first 3D representation; generating virtual sensor configuration data for the virtual sensor on the basis at least of the position of the beacon, the virtual sensor configuration data. representing: a volume area having a predefined positioning with respect to the beacon, at least one virtual sensor trigger condition associated with the volume area, and at least one operation to be triggered when said at least one virtual sensor trigger condition is fulfilled.

According to another aspect, the present disclosure relates to a system for configuring a virtual sensor in a real scene, the system comprising a configuration sub-system for obtaining a first three dimensional (3D) representation, wherein said at least one first 3D representation comprises points representing objects in the real scene and respective associated positions in the real scene; analyzing said at least one first representation to detect a beacon in the real scene, and computing a position of the beacon in the real scene from at least one position associated to a least one point of a set of points representing the beacon in said at least one first 3D representation; generating virtual sensor configuration data for the virtual sensor on the basis at least of the position of the beacon, the virtual sensor configuration data representing: a volume area having a predefined positioning with respect to the beacon, at least one trigger condition associated with the volume area, and at least one operation to be triggered when said at least one trigger condition is fulfilled, In one or more embodiment, the system further includes the beacon.

According to another aspect, the present disclosure relates to a beacon of a system for configuring a virtual sensor in a real scene, wherein the beacon is configured to be placed in the real scene so as to mark a position in the real scene, wherein the system comprises a configuration sub-system for: obtaining at least one first 3D representation of the real scene, wherein said at least one first 3D representation comprises points representing objects in the real scene and respective associated positions in the real scene; analyzing said at least one first 3D representation to detect a beacon in the real scene, and computing a position of the beacon in the real scene from at least one position associated to a least one point of a set of points representing the beacon in said at least one first 3D representation; generating virtual sensor configuration data for the virtual sensor on the basis at least of the position of the beacon, the virtual sensor configuration data representing a volume area having a predefined positioning with respect to the beacon, at least one trigger condition associated with the volume area, and at least one operation to be executed when said at least one trigger condition is fulfilled, wherein the beacon has a predefined property, wherein the position of the beacon in the real scene is determined from at least one position associated to a least one point of a set of points representing the beacon with the predefined property in said at least one first 3D representation.

According to another aspect, the present disclosure relates to a beacon of a system for configuring a virtual sensor in a real scene, wherein the beacon is configured to be placed in the real scene so as to mark a position in the real scene, wherein the system comprises a configuration sub-system for obtaining a first three dimensional (3D) representation of the real scene, wherein said at least one first 3D representation comprises points representing objects in the real scene and respective associated positions in the real scene; analyzing said at least one first 3D representation to detect a beacon in the real scene, and computing a position of the beacon in the real scene from at least one position associated to a least one point of a set of points representing the beacon in said at least one first 3D representation: generating virtual sensor configuration data for the virtual sensor on the basis at least of the position of the beacon, the virtual sensor configuration data representing: a volume area having a predefined positioning with respect to the beacon, at least one trigger condition associated with the volume area, and at least one operation to be executed when said at least one trigger condition is fulfilled; wherein the beacon comprises an emitter for emitting an optical signal, wherein the position of the beacon in the real scene is determined from at least one position associated to a least one point of a set of points representing an origin of the optical signal in said at least one first 3D representation,

According to another aspect, the present disclosure relates to a beacon of a system for configuring a virtual sensor in a real scene, wherein the beacon is configured to be placed in the real scene so as to mark a position in the real scene; wherein the system comprises a configuration sub-system for: obtaining a first three dimensional (3D) representation of the real scene, wherein said at least one first 3D representation comprises points representing objects in the real scene and respective associated positions in the real scene; analyzing said at least one first 3D representation to detect a beacon in the real scene, and computing a position of the beacon in the real scene from at least one position associated to a least one point of a set of points representing the beacon in said at least one first 3D representation; generating virtual sensor configuration data for the virtual sensor on the basis at least of the position of the beacon, the virtual sensor configuration data representing: a volume area having a predefined positioning with respect to the beacon, at least one trigger condition associated with the volume area, and at least one operation to be executed when said at least one trigger condition is fulfilled; wherein the beacon comprises at least one identification element, wherein the position of the beacon in the real scene is determined from at least one position associated to a least one point of a set of points representing said identification element in said at least one 3D representation.

It should be appreciated that the present method, system and beacon can be implemented and utilized in numerous ways, including without limitation as a process, an apparatus, a system, a device, and as a method for applications now known and later developed. These and other unique features of the system disclosed herein will become more readily apparent from the following description and the accompanying drawings.

### BRIEF DESCRIPTION OF THE DRAWINGS

The present subject disclosure will be better understood and its numerous objects and advantages will become more apparent to those skilled in the art by reference to the following drawings, in conjunction with the accompanying specification, in which:

FIG. 1 shows a system for configuring a virtual sensor and for detecting activation of a virtual sensor according to an example embodiment.

FIG. 2 illustrates a flow diagram of an exemplary method for configuring a virtual sensor according to an example embodiment.

FIG. 3 illustrates a flow diagram of an exemplary method for detecting activation of a virtual sensor according to an example embodiment.

FIGS. 4A 4C show examples in accordance with one or more embodiments of the invention.

FIG. 5 illustrates examples in accordance with one or more embodiments of the invention.

### DETAILED DESCRIPTION OF EMBODIMENTS

The advantages, and other features of the components disclosed herein, will become more readily apparent to those having ordinary skill in the art form. The following detailed description of certain preferred embodiments, taken in conjunction with the drawings, sets forth representative embodiments of the subject technology, wherein like reference numerals identify similar structural elements.

In addition, it should be apparent that the teaching herein can be embodied in a wide variety of forms and that any specific structure and/or function disclosed herein is merely representative. In particular, one skilled in the art will appreciate that an embodiment disclosed herein can be implemented independently of any other embodiments and that several embodiments can be combined in various ways.

In general, embodiments relate to simplifying and improving the generation of configuration data for a virtual sensor, wherein the configuration data include a volume area, at least one trigger condition associated with the volume area, and at least one operation to be executed when the trigger condition(s) is (are) fulfilled. In one or more embodiments, the generation of the configuration data may be performed without having to display any 3D representation of the captured scene 151 and/or to navigate in the 3D representation in order to determine the position of the virtual sensor. The position of the virtual sensor may be defined in an accurate manner by using a predefined object serving as a beacon to mark a spatial position (i.e. location in the scene. The detection of the beacon in the scene may be performed on the basis of predefined beacon description data. Further, predefined virtual sensor configuration data may be associated with a given beacon (e.g. with beacon description data) in order to automatically configure virtual sensors for the triggering of predefined operations. The positioning of the volume area of the virtual sensor in the scene with respect to the beacon may be predefined, i.e. the virtual sensor volume area may have a predefined position and/or spatial orientation with respect to the position and/or spatial orientation of the beacon.

The present disclosure is described below with reference to functions, engines, block diagrams and flowchart illustrations of the methods, systems, and computer program according to one or more exemplary embodiments. Each described function, engine, block of the block diagrams and flowchart illustrations can be implemented in hardware, software, firmware, middleware, microcode, or any suitable combination thereof. If implemented in software, the functions, engines, blocks of the block diagrams and/or flowchart illustrations can be implemented by computer program instructions or software code, which may be stored or transmitted over a computer-readable medium, or loaded onto a general purpose computer, special purpose computer or other programmable data processing apparatus to produce a machine, such that the computer program instructions or software code which execute on the computer or other programmable data processing apparatus, create the means for implementing the functions described herein.

Embodiments of computer-readable media includes, but are not limited to, both computer storage media and communication media including any medium that facilitates transfer of a computer program from one place to another. As used herein, a “computer storage media” may be any physical media that can be accessed by a computer. Examples of computer storage media include, but are not limited to, a flash drive or other flash memory devices (e.g. memory keys, memory sticks, key drive), CD-ROM or other optical storage, DVD, magnetic disk storage or other magnetic storage devices, memory chip, RAM, ROM, EEPROM, smart cards, or any other suitable medium from that can be used to carry or store program code in the form of instructions or data structures which can be read by a computer processor. Also, various forms of computer-readable media may transmit or carry instructions to a computer, including a router, gateway, server, or other transmission device, wired (coaxial cable, fiber, twisted pair, DSL cable) or wireless (infrared, radio, cellular, microwave). The instructions may comprise code from any computer-programming language, including, but not limited to, assembly, C, C++, Visual Basic, HTML, PHP, Java, Javascript, Python, and bash scripting.

Additionally, the word “exemplary” as used herein means serving as an example, instance, or illustration. Any aspect or design described herein as “exemplary” is not necessarily to be construed as preferred or advantageous over other aspects or designs.

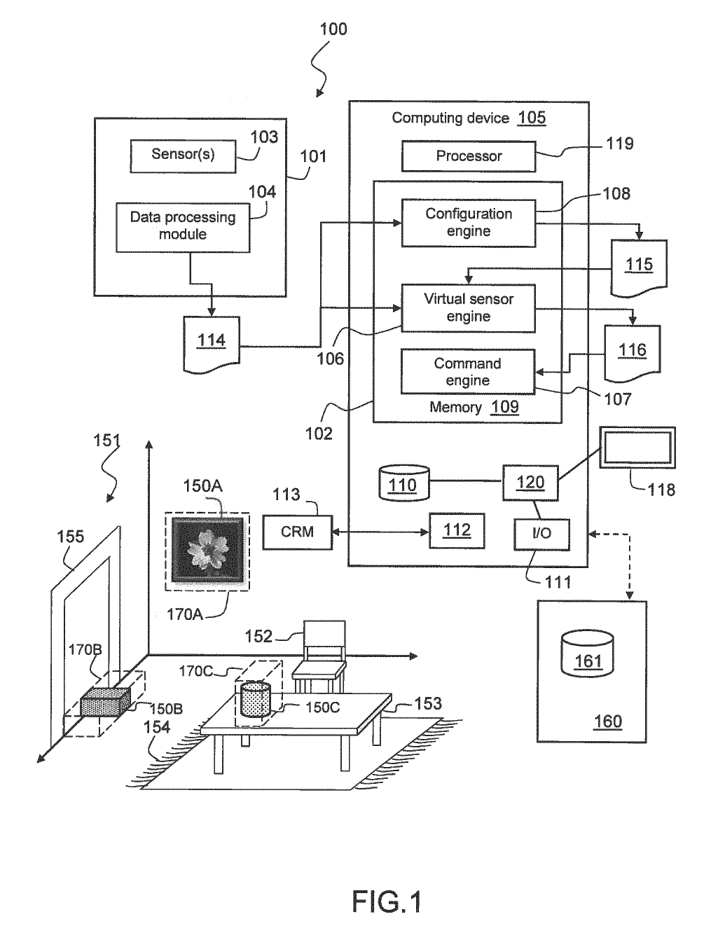

Referring to the figures, FIG. 1 illustrates an exemplary virtual sensor system 100 configured to use a virtual sensor feature in accordance with the present disclosure. The virtual sensor system 100 includes a scene capture subsystem 101, a virtual sensor sub-system 102 and one or more beacons 150A, 150B, 150C.

The scene 151 is a scene of a real world and will be also referred to herein as the real scene 151. The scene 151 may be an indoor scene or outdoor scene. The scene 151 may comprise one or more objects 152-155, including objects used as beacons 150A, 150B, 150C. An object of the scene may be any physical objects that is detectable by one of the sensors 103. A physical object of the scene may for example be a table 153, a chair 152, a bed, a computer, a picture 150A, a wall, a floor, a carpet 154, a door 155, a plant, an apple, an animal, a person, a robot, etc. The scene contains physical surfaces, which may be for example surfaces of objects in the scene and/or the surfaces of walls in case of an indoor scene. A beacon 1501, 150B, 150C in the scene is used for configuring at least one virtual sensor 170A, 170B, 170C.

The scene capture sub-system 101 is configured to capture the scene 151, to generate one or more captured representations of the scene and to provide a 3D representation 114 of the scene to the virtual sensor subsystem 102. In one or more embodiments, the scene capture subsystem 101 is configured to generate a 3D representation 114 of the scene to be processed by the virtual sensor subsystem.

In one or more embodiments, the 3D representation 114 comprises data representing surfaces of objects detected in the captured scene 151 in the scene by the sensor(s) 103 of the scene capture sub-system 101. The 3D representation 114 includes points representing objects in the real scene and respective positions in the real scene. More precisely, the 3D representation 114 represents the surface areas detected by the sensors 103, i.e. non-empty areas corresponding to surfaces of the surfaces of objects in the real scene. The points of a 3D representation correspond to or represent digital samples of one or more signals acquired by the sensors 103 of the scene capture sub-system 101.

In one or more embodiments, the scene capture sub-system 101 comprises one or several sensor(s) 103 and a data processing module 104. The sensor(s) 103 generate raw data, corresponding to one or more captured representations of the scene, and the data processing module 104 may process the one or more captured representations of the scene to generate a 3D representation 114 of the scene that is provided to the virtual sensor sub-system 102 for processing by the virtual sensor sub-system 102 and.

The data processing module 104 is operatively coupled to the sensor(s) 103 and configured to perform any suitable processing of the raw data generated by the sensor(s) 103. For example, in one or more embodiments, the processing may include transcoding raw data (i.e. the one or more captured representation(s)) generated by the sensor(s) 103 to data (i.e. the 3D representation 114) in a format that is compatible with the data format which the virtual sensor sub-system 102 is configured to handle. In one or more embodiment, the data processing module 104 may perform a combination of the raw data generated by several sensor(s) 103.

The sensors 103 of the scene capture subsystem 101 may use different sensing technologies and the sensor(s) 103 may be of the same or of different technologies. The sensors 103 of the scene capture subsystem 101 may be sensors capable of generating sensor data (raw data) which already include a 3D representation or from which a 3D representation of a scene can be generated. The scene capture subsystem 101 may for example comprise a single 3D sensor 103 or several 1D or 2D sensor(s) 103. The sensor(s) 103 may be distance sensors which generate one-dimensional position information representing a distance from one of the sensor(s) 103 of a point of an object 150 of the scene. In one or more embodiment, the sensor(s) 103 are image sensors, and may be infrared sensors, laser cameras, 3D cameras, stereovision system, time of flight sensors, light coding sensors, thermal sensors, LIDARS systems, etc. In one or more embodiment, the sensor(s) 103 are sound sensors, and may be ultrasound sensors, SONAR system, etc.

A captured representation of the scene generated by a sensor 103 comprises data representing points of objects in the scene and corresponding position information in a one-dimensional, two-dimensional or three-dimensional space. For each point of an object in the scene, the corresponding position information may be coded according to any coordinate system.

In the exemplary case where distance sensors are used, which generate point data with corresponding one-dimensional position information, three distance sensor(s) 103 may be used in a scene capture sub-system 101 and positioned with respect to the scene to be captured. When several distance sensor(s) 103 are positioned to capture the scene, each of the sensor(s) 103 may generate measure values, and the measured values generated by all sensor(s) 103 may be combined by the data processing module 104 to generate the 3D representation 114 comprising vectors of measure values.

In another exemplary embodiment, several sensors are used to capture the scene, and are positioned as groups of sensors wherein each group of sensors includes several sensors positioned with respect to each other in a matrix. In such case the measured values generated by all sensor(s) 103 may be combined by the data processing module 104 to generate the 3D representation 114 comprising matrices of measured values. In such case each value of a matrix of measured values may represent the output of a specific sensor 103.

In one or more embodiments, the scene capture sub-system 101 generates directly a 3D representation 114 and the generation of the 3D representation 114 by the data processing module 104 may be not necessary. For example, the scene capture sub-system 101 includes a 3D sensor 103 that is a 3D image sensor that generates directly a 3D representation 114 as 3D images comprising point cloud data. Point cloud data may be pixel data where each pixel data may include 3D coordinates with respect to a predetermined origin, and also include in addition to the 3D coordinate data other data such as color data, intensity data, noise data, etc. The 3D images may be coded as depth images or, more generally, as point clouds.

In one or more embodiments, one single sensor 103 is used which is a 3D image sensor that generates a depth image. A depth image may be coded as a matrix of pixel data where each pixel data may include a value representing a distance between an object of the captured scene 151 and the sensor 103. The data processing module 104 may generate the 3D representation 114 by reconstructing 3D coordinates for each pixel of a depth image, using the distance value associated therewith in the depth image data, and using information regarding optical features (such as, for example, focal length) of the image sensor that generated the depth image.

In one or more embodiments, the data processing module 104 is configured to generate, based on a captured representation of the scene captured by the sensor(s) 103, a 3D representation 114 comprising data representing points of a surfaces detected by the sensor(s) 103 and respective associated positions in the volume area corresponding to the scene. In one or more embodiments, the data representing a position respectively associated with a point may comprise data representing a triplet of 3D coordinates with respect to a predetermined origin. This predetermined origin may be chosen to coincide with one of the sensor(s) 103. When the 3D representation is a 3D image representation, a point of the 3D representation corresponds to a pixel of the 3D image representation.

As described above, in one or more embodiments in which the sensor(s) 103 include a 3D sensor that directly outputs the 3D representation 114, the generation of the 3D representation 114 by the data processing module 104 may not be necessary. In another embodiment, the generation of the 3D representation 114 may include transcoding image depth data into point cloud data as described above. In other embodiments, the generation of the 3D representation 114 may include combining raw data generated by a plurality of 1D and/or 2D and/or 3D sensors 103 and generating the 3D representation 114 based on such combined data.

It will be appreciated that although the sensor(s) 103 and data processing module 104 are illustrated as part of the scene capture sub-system 101, no restrictions are placed on the architecture of the scene capture sub-system 101, or on the control or locations of components 103 and 104. In particular, in one or more embodiments, part or all of components 103 and 104 may be operated under the control of different entities and/or on different computing systems. For example, the data, processing module 104 may be incorporated in a sensor 103 or be part of the virtual sensor sub-system 102.

Further, it should be noted that the data processing module 104 may include a processor-driven device, and include a processor and a memory operatively coupled with the processor, and may be implemented in software, in hardware, firmware or a combination thereof to achieve the capabilities and perform the functions described herein.

The virtual sensor sub-system 102 may include a processor-driven device, such as, the computing device 105 shown on FIG. 1. In the illustrated example, the computing device 105 is communicatively coupled with the scene capture sub-system 101 via suitable interfaces and communication links.

The computing device 105 may be implemented as a local computing device connected through a local communication link to the scene capture sub-system 101. The computing device 105 may alternatively be implemented as a remote server and communicate with the scene capture sub-system 101 through a data transmission link. The computing device 105 may for example receive data from the scene capture sub-system 101 via various data transmission links such a data transmission network, for example a wired (coaxial cable, fiber, twisted pair, DSL cable, etc.) or wireless (radio, infrared, cellular, microwave, etc.) network, a local area network (LAN), Internet area network (IAN), metropolitan area network (MAN) or wide area network (WAN) such as the Internet, a public or private network, a virtual private network (VPN), a telecommunication network with data transmission capabilities, a single radio cell with a single connection point like a Wifi or Bluetooth cell, etc.

The computing device 105 may be a computer, a computer network, or another device that has a processor 119, memory 109, data storage including a local repository 110, and other associated hardware such as input/output interfaces 111 (e.g. device interfaces such as USB interfaces, etc., network interfaces such as Ethernet interfaces, etc.) and a media drive 112 for reading and writing a computer storage medium 113. The processor 119 may be any suitable microprocessor, ASIC, and/or state machine. In one or more embodiments, the computer storage medium may contain computer instructions which, when executed by the computing device 105, cause the computing device 105 to perform one or more example methods described herein.

The computing device 105 may further include a user interface engine 120 operatively connected to a user interface 118 for providing feedback to a user. The user interface 118 is for example a display screen, a light emitting device, a sound emitting device, a vibration emitting device or any signal emitting device suitable for emitting a signal that can be detected (e.g. viewed, heard or sensed) by a user. The user interface engine may include a graphical display engine operatively connected to a display screen of the computer system 105. The computing device 105 may further include a user interface engine 120 for receiving and generating user inputs/outputs including graphical inputs/outputs, keyboard and mouse inputs, audio inputs/outputs or any other input/output signals. The user interface engine 120 may be a component of the virtual sensor engine 106, the command engine 107 and/or the configuration engine 108 or be implemented as a separate component. The user interface engine 120 may be used to interface the user interface 118 and/or one or more input 1 output interfaces 111 with the virtual sensor engine 106, the command engine 107 and/or the configuration engine 108. The user interface engine 120 are illustrated as software, but may be implemented as hardware or as a combination of hardware and software instructions.

In one or more embodiments, the computer storage medium 113 may include instructions for implementing and executing a virtual sensor engine 106, a command engine 107 and/or a configuration engine 108. In one or more embodiments, at least some parts the virtual sensor engine 106, the command engine 107 and/or the configuration engine 108 may be stored as instructions on a given instance of the storage medium 113, or in local data storage 110, to be loaded into memory 109 for execution by the processor 119. Specifically, software instructions or computer readable program code to perform embodiments may he stored, temporarily or permanently, in whole or in part, on a non-transitory computer readable medium such as a compact disc (CD), a local or remote storage device, local or remote memory, a diskette, or any other computer readable storage device.

In the shown implementation, the computing device 105 implements one or more components, such as the virtual sensor engine 106, the command engine 107 and the configuration engine 108. The virtual sensor engine 106, the command engine 107 and the configuration engine 108 are illustrated as being software, but can be implemented as hardware, such as an application specific integrated circuit (ASIC) or as a combination of hardware and software instructions.

When executing, such as on processor 119, the virtual sensor engine 106 is operatively connected to the command engine 107 and to the configuration engine 108. For example, the virtual sensor engine 106 may be part of a same software application as the command engine 107 and/or the configuration engine 108, the command engine 107 may be a plug-in for the virtual sensor engine 106, or another method may be used to connect the command engine 107 and/or the configuration engine 108 to the virtual sensor engine 106.

It will be appreciated that the virtual sensor system 100 shown and described with reference to FIG. 1 is provided by way of example only. Numerous other architectures, operating environments, and configurations are possible. Other embodiments of the system may include fewer or greater number of components, and may incorporate some or all of the functionality described with respect to the system components shown in FIG. 1. Accordingly, although the sensor(s) 103, the data processing module 104, the virtual sensor engine 106, the command engine 107, the configuration engine 108, the local memory 109, and the data storage 110 are illustrated as part of the virtual sensor system 100, no restrictions are placed on the position and control of components 103-104-106-107-108-109-110-111-112. In particular, in other embodiments, components 103-104-106-107-108-109-110-111-112 may be part of different entities or computing systems.

The virtual sensor system 100 may further include a repository 110, 161 configured to store virtual sensor configuration data and beacon description data. The repository 110, 161 may be located on the computing device 105 or be operatively connected to the computer device 105 through at least one data transmission link. The virtual sensor system 100 may include several repositories located on physically distinct computing devices, for example a local repository 110 located on the computing device 105 and a remote repository 161 located on a remote server 160.

The configuration engine 108 includes functionality to generate virtual sensor configuration data 115 for one or more virtual sensors and to provide the virtual sensor configuration data 115 to the virtual sensor engine 106.

The configuration engine 108 includes functionality to obtain one or more 3D representations 114 of the scene. A 3D representation 114 of the scene may be generated by the scene capture sub-system 101. The 3D representation 114 of the scene may be generated from one or more captured representations of the scene or may correspond to a captured representation of the scene without modification. The 3D representation 114 may be a point cloud data representation of the captured scene 151.

When executing, such as on processor 119, the configuration engine 108 is operatively connected to the user interface engine 120. For example, the configuration engine 108 may be part of a same software application as the user interface engine 120. For example the user interface engine 120 may each be a plug-in for the configuration engine 108, or another method may be used to connect the user interface 120 to the configuration engine 108.

In one or more embodiments, the configuration engine 108 includes functionality to define and configure a virtual sensor, for example via the user interface engine 120 and the user interface 11.8. In one or more embodiments, the configuration engine 108 is operatively connected to the user interface engine 120.

In one or more embodiments, the configuration engine 108 includes functionality to provide a user interface for a virtual sensor application, e.g. for the definition and configuration of virtual sensors. The configuration engine 108 includes functionality to receive a 3D representation 114 of the scene, as may be generated and provided thereto by the scene capture sub-system 101 or by the virtual sensor engine 106. The configuration engine 108 may provide to a user information on the 3D representation through a user interface 118. For example, the configuration engine 108 may display the 3D representation on a display screen 118.

The virtual sensor configuration data 115 of a virtual sensor may include data representing a virtual sensor volume area. The virtual sensor volume area defines a volume area in the captured scene 151 in which the virtual sensor may be activated when an object enters this volume area. The virtual sensor volume area is a volume area that falls within the sensing volume area captured by the one or more sensors 103. The virtual sensor volume area may be defined by a position and a geometric form.

For example, the geometric form of a virtual sensor may define a two-dimensional surface or a three-dimensional volume. The definition of the geometric form of a virtual sensor may for example include the definition of a size and a shape, and, optionally, a spatial orientation of the shape when the shape is other than a sphere.

In one or more embodiments, the geometric form of the virtual sensor represents a set of points and their respective position with respect to a predetermined origin in the volume area of the scene captured by the scene capture sub-system 101. The position(s) of these points may be defined according to any 3D coordinate system, for example by a vector (x,y,z) defining three coordinates in a Cartesian 3D coordinate system.

Examples of predefined geometric shapes include, but are not limited to, square shape, rectangular shape, polygon shape, disk shape, cubical shape, rectangular solid shape, polyhedron shape, spherical shape. Examples of predefined sizes may include, but are not limited to, 1 cm (centimeter), 2 cm, 5 cm, 10 cm, 15 cm, 20, cm, 25 cm, 30 cm, 50 cm. The size may refer to the maximal dimension (width, height or depth) of the geometric shape or to a size (width, height or depth) in one given spatial direction of a 3D coordinate system. Such predefined geometric shapes and sizes are parameters whose values are input to the virtual sensor engine 106.

The position of the virtual sensor volume area may be defined according to any 3D coordinate system, for example by one or more vector (x,y,z) defining three coordinates in a Cartesian 3D coordinate system. The position of the virtual sensor volume area may correspond to the position, in the captured scene 151, of an origin of the geometric form of the virtual sensor, of a center of the geometric form of the virtual sensor or of one or more particular points of the geometric form of the virtual sensor. For example, if the geometric form of the virtual sensor is a parallelepiped, then the volume area of the virtual sensor may be defined by the positions of the 8 corners of the parallelepiped (i.e. by 8 vectors (x,y,z)) or alternatively, by a position of one corner of the parallelepiped (i.e. by 1 vector (x,y,z)) and by the 3 dimensions (e.g. width, height and depth) of the parallelepiped in the 3 spatial directions.

The virtual sensor configuration data 115 includes data representing one or more virtual sensor trigger conditions for a virtual sensor. For a same virtual sensor, one or more associated operations may be triggered and for each associated operation, one or more virtual sensor trigger conditions that have to be fulfilled for triggering the associated operation may be defined.

In one or more embodiments, a virtual sensor trigger condition may be related to any property and/or feature of points of the 3D representation 114 of the scene that fall inside the virtual sensor volume area, or to a combination of such properties or features. As the 3D representation 114 represent surfaces of objects in the scene, i.e. non-empty areas of the scene, the number of points of the 3D representation 114 that fall in a volume area is indicative of the presence of an object in that volume area.

In one or more embodiments, the virtual sensor trigger condition may be defined by one or more thresholds, for example by one or more minimum thresholds and, optionally, by one or more maximum thresholds. Specifically, a virtual sensor trigger condition may be defined by a value range, i.e. a couple consisting of a minimum threshold and a maximum threshold. In one or more embodiments, a minimum (respectively maximum) threshold corresponds to a minimum (respectively maximum) number of points of the 3D representation 114 that fulfill a given condition.

The threshold may correspond to a number of points beyond which the triggering condition of the virtual sensor will be considered fulfilled. Alternatively, as each point in a 3D representation represents a surface having an area depending on the distance to the camera, the threshold may also be expressed as a surface threshold.

For example, the virtual sensor trigger condition may be related to a number of points of the 3D representation 114 of the scene that fall inside the virtual sensor volume area and the virtual sensor trigger condition is defined as a minimal number of points. In such case, the virtual sensor trigger condition is considered as being fulfilled if the number of points that fall inside the virtual sensor volume area is greater than this minimal number. Thus, the triggering condition may be considered fulfilled if an object enters the volume area defined by the geometric form and position of the virtual sensor resulting in a number of points above the specified threshold.

For example, the virtual sensor trigger condition may be related to a number of points of the 3D representation 114 of the scene that fall inside the virtual sensor volume area and the virtual sensor trigger condition is defined both as a minimal number of points and a maximum number of points. In such case, the virtual sensor trigger condition is considered as being fulfilled if the number of points that fall inside the virtual sensor volume area is greater than this minimal number and lower than this maximum number.

The object used to interact with the virtual sensor may be any kind of physical object, comprising a part of the body of a user (e.g. hand, limb, foot), or any other material object like a stick, a box, a pen, a suitcase, an animal, etc. The virtual sensor and the triggering condition may be chosen based on the way the object is expected to enter the virtual sensor's volume area. For example, if we expect a finger to enter the virtual sensor volume area in order to fulfill the triggering condition, the size of the virtual sensor and/or the virtual sensor trigger condition may not be the same as if we expect a hand or a full body to enter the virtual sensor's volume area to fulfill the triggering condition.

For example, the virtual sensor trigger condition may further be related to the intensity of points of the 3D representation 114 of the scene that fall inside the virtual sensor volume area and the virtual sensor trigger condition is defined as an intensity range. In such case, the virtual sensor trigger condition is considered as being fulfilled if the number of points whose intensity falls in said intensity range is greater than the given minimal number of points.

For example, the virtual sensor trigger condition may further be related to the color of points of the 3D representation 114 of the scene that fall inside the virtual sensor volume area and the virtual sensor trigger condition is defined as a color range. In such case, the virtual sensor trigger condition is considered as being fulfilled if the number of points whose color falls in said color range is greater than the given minimal number of points.

For example, the virtual sensor trigger condition may be related to the surface area (or respectively a volume area) occupied by points of the 3D representation 114 of the scene that fall inside the virtual sensor volume area and the virtual sensor trigger condition is defined as a minimal surface (or respectively a minimal volume). In such case, the virtual sensor trigger condition is considered as being fulfilled if the surface area (or respectively the volume area) occupied by points of the 3D representation 114 of the scene that fall inside the virtual sensor volume area is greater than a given minimal surface (or respectively volume), and, and optionally, lower than a given maximal surface (or respectively volume). As each point of the 3D representation corresponds to a volume area that follows a geometry relative to the camera, a correspondence between the position of points and the corresponding surface (or respectively volume) area that these points represent may be determined, a surface (or respectively volume) defining a threshold may also be defined as a point number threshold.

The virtual sensor configuration data 115 includes data representing the one or more associated operations to be executed in response to determining, that one or several of the virtual sensor trigger conditions are fulfilled.

In one or more embodiments, a temporal succession of 3D representations is obtained and the determination that a trigger condition is fulfilled may be performed for each 3D representation 114. In one or more embodiments, the one or more associated operations may be triggered when the trigger condition starts to be fulfilled for a given 3D representation in the temporal succession or ceases to be fulfilled for a last 3D representation in the temporal succession. In one embodiment, a first operation may be triggered when the trigger condition starts to be fulfilled for a given 3D representation in the succession and another operation may be triggered when the trigger condition ceases to be fulfilled for a last 3D representation in the succession.

In one or more embodiments, the one or more operations may be triggered when the trigger condition is riot fulfilled during a given period of time or, on the contrary, when the trigger condition is fulfilled during a period longer than a threshold period.

The associated operation(s) may be any operation that may be triggered or executed by the computing device 105 or by another device operatively connected to the computing device 105. For example, the virtual sensor configuration data 115 may include data identifying a command to be sent to a device that triggers the execution of the associated operation or to a device that executes the associated operation,

For example, the associated operations may comprise activating,/deactivating a switch in a real world object (e.g. lights, heater, cooling system, etc.) or in a virtual object (e.g. launching/stopping a computer application), controlling a volume of audio data to a given value, controlling the intensity of light of a light source, or more generally controlling the operating of a real world object or a virtual object, e.g. locking the doors, windows and any access to a room, house, apartment, office or building in general, activating or updating the content of a digital signage, signboard, hoarding, taking a picture using a webcam, a video camera, a digital camera, or any other device, storing the taken picture, send it to a particular website, mail, telephone number, etc. Associated operations may further comprise generating an alert, activating an alarm, sending a message (an email, a SMS or any other communication form), monitoring that a triggering action was fulfilled for example for data mining purposes.

The associated operations may further comprise detecting a user's presence, defining and/or configuring a new virtual sensor, or modifying and/or configuring an existing virtual sensor. For example, a first virtual sensor may be used to detect the presence of one or a plurality of users, and a command action to be executed responsive to determining that one or several of the trigger conditions of the first virtual sensor is/are fulfilled may comprise defining and/or configuring further virtual sensors associated to each of said user(s).

The virtual sensor engine 106 includes functionality to obtain a 3D representation 114 of the scene. The 3D representation 114 of the scene may be generated by the scene capture sub-system 101. The 3D representation 114 of the scene may be generated from one or more captured representations of the scene or may correspond to a captured representation of the scene without modification. The 3D representation 114 may be a point cloud data representation of the captured scene 151.

When executing, such as on processor 119, the virtual sensor engine 106 is operatively connected to the user interface engine 120. For example, the virtual sensor engine 106 may be part of a same software application as the user interface engine 120. For example, the user interface engine 120 may be a plug-in for the virtual sensor engine 106, or another method may be used to connect the user interface engine 1.20 to the virtual sensor engine 106,

In this example embodiment, the computing device 105 receives incoming 3D representation 114, such as 3D image data representation of the scene, from the scene capture sub-system 101, and possibly via various communication means such as a USB connection or network devices. The computing device 105 can receive many types of data sets via the input/output interfaces 111, which may also receive data from various sources such as the interact or a local network.

The virtual sensor engine 106 includes functionality to analyze the 3D representation 114 of the scene in the volume area corresponding to the geometric form and position of a virtual sensor. The virtual sensor engine 106 further includes functionality to determine whether the virtual sensor trigger condition is fulfilled based on such analysis.

The command engine 107 includes functionality to trigger the execution of an operation upon receiving information that a corresponding virtual sensor trigger condition is fulfilled. The virtual sensor engine 106 may also generate or ultimately produce control signals to be used by the command engine 107, for associating an action or command with detection of a specific triggering condition of a virtual sensor.

Configuring a Virtual Sensor

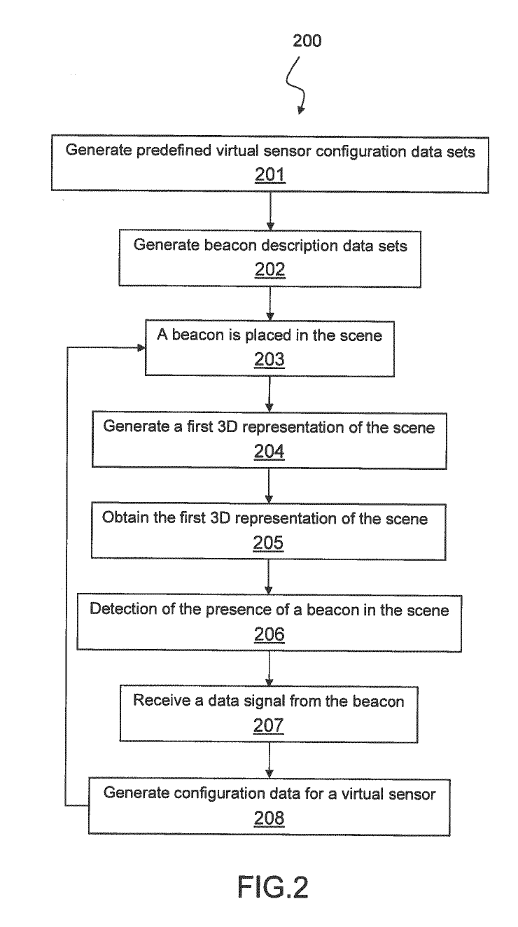

FIG. 2 shows a flowchart of a method 200 for configuring a virtual sensor according to one or more embodiments. While the various steps in the flowchart are presented and described sequentially, one of ordinary skill will appreciate that some or all of the steps may be executed in different orders, may be combined or omitted, and some or all of the steps may be executed in parallel.

The method 200 for configuring a virtual sensor may be implemented using the exemplary virtual sensor system 100 described above, which includes the scene capture sub-system 101 and the virtual sensor sub-system 102. In the following reference will be made to components of the virtual sensor system 100 described with respect to FIG. 1.

Step 201 is optional and may be executed to generate one or more sets of virtual sensor configuration data. Each set of virtual sensor configuration data may correspond to default or predefined virtual sensor configuration data.

In step 201, one or more set of virtual sensor configuration data are stored in a repository 110, 161. The repository may be a local repository 110 located on the computing device 105 or a remote repository 161 located on a remote server 160 operatively connected to the computing device 105. A set of virtual sensor configuration data may be stored in association with configuration identification data identifying the set of virtual sensor configuration data.

A set of virtual sensor configuration data may comprise a virtual sensor type identifier identifying a virtual sensor type. A set of virtual sensor configuration data may comprise data representing at least one volume area, at least one virtual sensor trigger condition and or at least one associated operation.

Predefined virtual sensor types may be defined depending on the type of operation that might be trigger upon activation of the virtual sensor. Predefined virtual sensor types may include a virtual button, a virtual slider, a virtual barrier, a virtual control device, a motion detector, a computer executed command, etc.

A virtual sensor used as a virtual button may be associated with an operation which corresponds to a switch on/off of one or more devices and/or the triggering of a computer executed operation. The volume area of a virtual sensor which is a virtual button may be rather small, for example less than 5 cm, defined by a parallelepipedic/spherical geometric form in order to simulate the presence of a real button.

A virtual sensor used as a virtual slider may be associated with an operation which corresponds to an adjustment of a value of a parameter between a minimal value and a maximal value. The volume area of a virtual sensor which is a virtual slider may be of medium size, for example between 5 and 60 cm, defined by a parallelepipedic geometric form having a width/height much higher that the height/width in order to simulate the presence of a slider.

A virtual sensor used as a virtual barrier may be associated with an operation which corresponds to the triggering of an alarm and/or the sending of a message and/or the triggering of a computer executed operation. The volume area of a virtual sensor which is a barrier may have any size depending on the targeted use, and may be defined by a parallelepipedic geometric form. For a virtual barrier, the direction in which the person/animal/object crosses the virtual barrier may be determined: in a first direction, a first action may be triggered and in the other direction, another action is triggered.

A virtual sensor may further be used as a virtual control device, e.g. a virtual touchpad, as a virtual mouse, as a virtual touchscreen, as a virtual joystick, as a virtual remote control or any other input device used to control a PC or any other device like tablet, laptop, smartphone.

A virtual sensor may be used as a motion detector to track specific motions of a person or an animal, for example to determine whether a person falls or is standing, to detect whether a person did not move over a given period of time, to analyze the walking speed, determine the center of gravity, and compare performances over time by using a scene capture sub-system 101 including sensors placed in the scene at different heights. The determined motions may be used for health treatment, medical assistance, automatic performances measurements, or to improve sport performances, etc. A virtual sensor may be used for example to perform reeducation exercises. A virtual sensor may be used for example to detect if the person approached the place where their medications are stored, to record the corresponding time of the day and to provide medical assistance on the basis of this detection.

A virtual sensor used as a computer executed command may be associated with an operation which corresponds to the triggering of one or more computer executed command. The volume area of the corresponding virtual sensor may have any size and any geometric form. The computer executed command may trigger a web connection to a given web page, a display of information, a sending of a message, a storage of data, etc.

In step 202, one or more sets of beacon description data are stored in a data repository 110, 161. Each set of beacon description data may correspond to a default beacon or a predefined beacon.

In one or more embodiment, sets of beacon description data are stored in a repository 110, 161. The repository 110, 161 may be a local repository 110 located on the computing device 105 or a remote repository 161 located on a remote server 160 operatively connected to the computing device 105. A set of beacon description data may be stored in association with beacon identification data identifying the set of beacon description data. A set of beacon description data may further be stored in association with a set of virtual sensor configuration data, a virtual sensor type, a virtual sensor trigger condition and/or at least one operation to be triggered.

A set of beacon description data may further comprise function identification data identifying a processing function to be applied to a 3D representation of the scene for detecting the presence of a beacon in the scene represented by the 3D representation. A set of beacon description data may comprise computer program instructions for implementing the processing function to be executed by the computing device 105 for detecting the presence of a beacon in the scene. The computer program instructions may be stored included in the set of beacon description data or stored in association with one or more sets of beacon description data.

A set of beacon description data may comprise data defining an identification element of the beacon. The identification element may be a reflective surface, a surface with a predefined pattern or a predefined text or a predefined number, an element having a predefined shape, an element having a predefined color, an element having a predefined size, an element having predefined reflective properties.

When the identification element is a surface with a predefined pattern, the beacon description data include a representation of the predefined pattern or the predefined text or a predefined number. When the identification element is an element having a predefined shape, the beacon description data include a representation of the predefined shape. When the identification element is an element having a predefined color, the beacon description data include a representation of the predefined color, for example a range of pixel values in which the points. When the identification element is an element having a predefined size, the beacon description data include a value or a range of values in which the size of the detected object has to fall. When the identification element is an element having a predefined reflective properties, the beacon description data include a pixel value or a range of pixel values in which the values of the pixels representing the detected object have to fall.

In step 203, a beacon, for example beacon 150A, is placed in the scene. The beacon 150A may be placed anywhere in the scene. For example, the beacon may be placed on a table, on the floor, on a furniture or just held by a user at a given position in the scene. The beacon 150A is placed so as to be detectable (e.g. not hidden by another object or by the user himself) in the representation of the real scene that will be obtained at step 204. Depending on the distance to the camera and of the sensor technology, the lowest possible size for a detectable beacon may vary from 1 cm for a distance lower than 1 meter up to I m for a distance up to 6 or 7 meters.

Any physical object having at least one identification element and/or at least one property that is detectable in a 3D representation 114 of the scene may be used as a beacon for configuring a virtual sensor. A beacon may be any kind of physical object for example a part of the body of a person or an animal (e.g. hand, limb, foot, face, eye(s), . . . ), or any other material object like a stick, a box, a pen, a suitcase, an animal, a picture, a glass, a post-it, a connected watch, a mobile phone, a lighting device, a robot, a computing device, etc. The beacon may also be fixed or moving. The beacon may be a part of the body of the user, this part of the body may be fixed or moving, e.g. performing a gesture/motion.

The beacon may be a passive beacon or an active beacon. An active beacon is configured to emit at least one signal while a passive beacon is not. For example, an active beacon may be a connected watch, a mobile phone, a lighting device, etc.

In step 204, at least one first 3D representation 114 of the real scene including the beacon 150A, 150B or 150C is generated by the scene capture sub-system 101. In one or more embodiments, one or more captured representations of the scene are generated by the scene capture sub-system 101 and one or more first 3D representations 114 of the real scene including the beacon 150A are generated on the basis of the one or more captured representations. A first 3D representation is for example generated by the scene capture sub-system 101 according to any know technology/process, or according to any technology/process described therein. Once the first 3D representation 114 of the real scene including the beacon 150A is obtained, the beacon 150A may be removed from the scene or may be moved elsewhere, for example so as to define another virtual sensor.

In step 205, one or more first 3D representations 114 of the scene are obtained by the virtual sensor sub-system 102. The one or more first 3D representations 114 of the scene may be a temporal succession of first 3D representations generated by the scene capture sub-system 101.

In one or more embodiments, each first 3D representation obtained at step 205 comprises data representing surfaces of objects detected in the scene by the sensors 103 of the scene capture sub-system 101. The first 3D representation comprise a set of points representing objects in the scene and respective associated position. Upon reception of the 3D representation 114, the virtual sensor sub-system 102 may provide to a user some feedback on the received 3D representation through a user interface 118. For example, the virtual sensor sub-system 102 may display on the display screen 118 an image of the 3D representation 114, which may be used for purposes of defining and configuring 301 a virtual sensor in the scene. A position of a point of an object in the scene may be represented by a 3D coordinates with respect to a predetermined origin. The predetermined origin may for example be a 3D camera in the case where the scene is captured by a sensor 103 which is a 3D image sensor (e.g. a 3D camera). In one or more embodiments, the data representing a point of the set of points may include, in addition to the 3D coordinate data, other data such as color data, intensity data, noise data, etc.

In step 206, each first 3D representation 114 obtained at step 205 is analyzed by the virtual sensor sub-system 102. In one or more embodiment, the analysis if performed on the basis of predefined beacon description data so as to detect the presence in the scene of predefined beacons. On the basis of the analysis, the presence in the real scene of at least a first beacon 150A is detected in the first 3D representation 114 and the position of a beacon in the real scene is computed. The beacon description data specify an identification element of the beacon and/or a property of the beacon on the basis of which the detection of the beacon may be performed.

In one or more embodiments, the analysis of the 3D representation to detect a beacon in the real scene comprises: obtaining beacon description data that specifies at least one identification element of the beacon and executing a processing function to detect points of the 3D representation that represents an object having this identification element. In one or more embodiments, the analysis of the 3D representation to detect a beacon in the real scene comprises: obtaining beacon description data that specifies at least one property of the beacon and executing a processing function to detect points of the 3D representation that represents an object having this property.

In one or more embodiments, the analysis of the first 3D representation 114 includes the execution of a processing function identified by function identification data in one or more sets of predefined beacon description data. In one or more embodiments, the analysis of the first 3D representation 114 includes the execution of computer program instructions associated with the beacon. These computer program instructions may be stored in association with one or more sets of predefined beacon description data or included in one or more set of predefined beacon description data. When loaded and executed by the computing device, these computer program instructions cause the computing device 105 to perform one or more processing functions for detecting the presence in the first 3D representation 114 of one or more predefined beacons. The detection may be performed in the basis of one or more sets of beacon description data stored at step 202 or beacon description data encoded directly into the computer program instructions.

In one or more embodiments, the virtual sensor subsystem 102 implement one or more data processing functions (e.g. 3D representation processing algorithms) for detecting the presence in the first 3D representation 114 of predefined beacons based on one or more sets of beacon description data obtained at step 202. The data processing functions may for example include shape recognition algorithms, pattern detection algorithms, text recognition algorithms, color analysis algorithms, segmentation algorithms, or any other algorithm for image segmentation and/or object detection.

In at least one embodiment, the presence of the beacon in the scene is detected on the basis of a predefined property of the beacon. The predefined property and/or an algorithm for detecting the presence of the predefined property may be specified in a set of beacon description data stored in step 202 for the beacon. The predefined property may be a predetermined shape, color, size, reflective property or any other property that is detectable in the first 3D representation 114. The position of the beacon in the scene may thus be determined from at least one position associated to a least one point of a set of points representing the beacon with the predefined property in the first 3D representation 114.

In at least one embodiment, the presence of the beacon in the scene is detected on the basis of an identification element of the beacon. The identification element and/or an algorithm for detecting the presence of the identification element may be specified in a set of beacon description data stored in step 202 for the beacon. The identification element may be a reflective surface, a surface with a predefined pattern, an element having a predefined shape, an element having a predefined color, an element having a predefined size, an element having predefined reflective property. The position of the beacon in the scene may thus be determined from at least one position associated to a least one point of a set of points representing the identification element of the beacon in the first 3D representation 114.

For example, when the identification element of the beacon is an element having a predefined reflective property or the beacon itself has a predefined reflective property, the virtual sensor sub-system 102 is configured to search for an object having predefined pixel values representative of the reflective property. For example, the pixels that have a luminosity above a given threshold or within a given range are considered to be part of the reflective surface.

For example, when the identification element of the beacon is an element having a predefined color or the beacon itself has a predefined color, the virtual sensor sub-system 102 is configured to search for an object having a specific color or a specific range of colors.

For example, when the identification element of the beacon is an element having a predefined shape or the beacon itself has a predefined shape, the virtual sensor sub-system 102 is configured to detect specific shapes by performing a shape recognition and a segmentation of the recognized objects.

For example, when the identification element of the beacon is an element having both a predefined shape and predefined color or the beacon itself has both a predefined shape and predefined color, the virtual sensor sub-system 102 first searches for an object having a specific color or a specific range of colors and then select the objects that match the predefined shape, or alternatively, the virtual sensor sub-system 102 first searches for objects that match the predefined shape and then discriminate them by searching for an object having a specific color or a specific range of colors.

For example, the beacon may be a post-it with a given color and/or size/and/or shape. For example, the beacon may be an e-paper having a specific color and/or shape. For example, the beacon may be a picture on a wall having a specific content.

In at least one embodiment, the beacon is an active beacon and the presence of the beacon in the scene is detected on the basis of a position signal emitted by the beacon.

For example, the beacon includes an emitter for emitting an optical signal, a sound signal or any other signal whose origin is detectable in the first 3D representation 114. The position of the beacon in the scene may be determined from at least one position associated to a least one point of a set of points representing the origin of the position signal in the first 3D representation 114.

For example, when the beacon comprises an emitter for emitting an optical signal (e.g. an infrared signal), the virtual sensor sub-system 102 searches pixels in the 3D image representation 114 having a specific luminosity and/or color corresponding to the expected optical signal. In one or more embodiments, the color of optical signal changes according to a sequence of colors and the virtual sensor sub-system 102 is configured to search pixels in the 3D image representation 114 whose color changes according to this specific color sequence. The color sequence is stored in the beacon description data.

For example, when the beacon comprises an emitter which is switched on and off so as to repeatedly emit at a given frequency an optical signal, the virtual sensor sub-system 102 is configured to search pixels in a temporal succession of 3D image representations 114 having a specific luminosity and/or color corresponding to the expected optical signals and to determine the frequency at which the detected optical signals are emitted from the acquisition frequency of the temporal succession of 3D image representations 114. The frequency is stored in the beacon description data.

In one or more embodiments, the position and/or spatial orientation of the beacon in the scene is computed from one or more positions associated with one or more points of a set of points representing the beacon detected in the first 3D representation 114. The position and/or spatial orientation of the beacon may be defined by one or more coordinates and/or one or more rotation angles in spatial coordinate system. The position of the beacon may be defined as a center of the volume area occupied by the beacon, as a specific point (e.g. corner) of the beacon, as a center of a specific surface (e.g. top surface) of the beacon etc. The position of the beacon and/or an algorithm for computing the position of the beacon may be specified in a set of beacon description data stored in step 202 for the beacon.

In one or more embodiment, the beacon comprises an emitter for emitting at least one optical signal, and the position and i or spatial orientation of the beacon in the real scene is determined from one or more positions associated to one or more points of a set of points representing an origin of the optical signal.

In one or more embodiment, the beacon comprises at least one identification element, and the position and/or spatial orientation of the beacon in the real scene is determined from one or more positions associated to one or more points of a set of points representing said identification element.

In one or more embodiment, the beacon has a predefined property, wherein the position and/or spatial orientation of the beacon in the real scene is determined from one or more positions associated to one or more points of a set of points representing the beacon with the predefined property.

Step 207 is optional and may be implemented to provide to the virtual sensor sub-system 102 additional configuration data for configuring the virtual sensor. In step 207, one or more data signal(s) emitted by the beacon are detected, the data signal(s) encoding additional configuration data including configuration identification data and/or virtual sensor configuration data. The additional configuration data are extracted and analyzed by the virtual sensor sub-system 102. The additional configuration data may for example identify a set of virtual sensor configuration data. The additional configuration data may for example represent a value of one or more configuration parameters of the virtual sensor. The one or more data signal(s) may be optical signals, or any radio signal like a radio-frequency signals, Wi-Fi signals, Bluetooth signals, etc. The additional configuration data may be encoded by the one or more data signal(s) according to any coding scheme.

The additional configuration data may represent value(s) of one or more configuration parameters of the following list: a geometric form of the virtual sensor volume area, a size of the virtual sensor volume area, one or more virtual sensor trigger conditions, one or more associated operations to be executed when a virtual sensor trigger condition is fulfilled. For example, the additional configuration data may comprise an operation identifier that identifies one or more associated operations to be executed when a virtual sensor trigger condition is fulfilled. The additional configuration data may comprise a configuration data set identifier that identifies a predefined virtual sensor configuration data set. The additional configuration data may comprise a virtual sensor type from a list of virtual sensor types.

In one or more embodiments, the one or more data signal(s) are response signal(s) emitted in response to the receipt of a source signal emitted towards the beacon. The source signal may for example be emitted by the virtual sensor sub-system 102 or any other device.

In one or more embodiments, the one or more data signal(s) comprises several elementary signals that are used to encode the additional configuration data. The additional configuration data may for example be coded in dependence upon a number of elementary signals in data signal or a rate/frequency/frequency band at which the elementary signals are emitted.

In one or more embodiments, the one or more data signal(s) are emitted upon activation of an actuator of that triggers the emission of the one or more data signal(s). The activation of the actuator may be performed by the user or by any other device operatively coupled with the beacon. An actuator may be any button or mechanical or electronical user interface item suitable for triggering the emission of one or more data signals. In one or more embodiments, the beacon comprises several actuators, each actuator being configured to trigger the emission of an associated data signal. For example, with a first button, a single optical signal is emitted by the beacon, therefore the virtual sensor type correspond to a first predefined virtual sensor type. Upon activation of a second button, two optical signals are emitted by the beacon, therefore the virtual sensor type correspond to a second predefined virtual sensor type. Upon activation of a third button, three optical signals may be emitted by the beacon, therefore the virtual sensor type correspond to a third predefined virtual sensor type.

In step 208, virtual sensor configuration data 115 for the virtual sensor are generated on the basis at least of the position of the beacon computed at step 206 and, optionally, on the basis of the additional configuration data transmitted at step 207, on the basis of one or more set of virtual sensor configuration data stored in a repository 110, 161 at step 201, on the basis of one or more user inputs. In one or more embodiments, a user of the virtual sensor sub-system 102 may be requested to input or select further virtual sensor configuration data using a user interface 118 of the virtual sensor sub-system 102 to replace automatically defined virtual sensor configuration data or to define undefined/missing virtual sensor configuration data. For example, a user may change the virtual sensor configuration data 115 computed by the virtual sensor subsystem 102.

In one or more embodiments, when the set of beacon description data of the detected beacon is stored in association with a set of virtual sensor configuration data, a virtual sensor type, a virtual sensor trigger condition and/or at least one operation to be triggered, the virtual sensor configuration data 115 are generated on the basis of the associated set of virtual sensor configuration data, the associated virtual sensor type, the associated virtual sensor trigger condition and/or the associated operation(s) to be triggered. For example, at least one of the virtual sensor configuration data (volume area, virtual sensor trigger condition and/or operation(s) to be triggered) may be extracted from the associated data (the associated set of virtual sensor configuration data, the associated virtual sensor type, the associated virtual sensor trigger condition and/or the associated operation(s) to be triggered).

In one or more embodiments, the generation of the virtual sensor configuration data 115 comprise: generating data representing a volume area having at a predefined positioning with respect to the beacon, generating data representing at least one virtual sensor trigger condition associated with the volume area, and generating data representing at least one operation to be triggered when said at least one virtual sensor trigger condition is fulfilled. The determination of the virtual sensor volume area includes the determination of a geometric form and position of the virtual sensor volume area.

The predefined positioning (also referred to herein as the relative position) of the virtual sensor volume area with respect to the beacon may be defined in the beacon description data. The data defining the predefined positioning may include one or more distances and/or one or more rotation angles when the beacon and the virtual sensor volume area may have different spatial orientations. In the absence of a predefined positioning in the beacon description data, a default positioning of the virtual sensor volume area with respect to the beacon may be used as the predefined positioning. This default positioning may be defined such that the center of the virtual sensor volume area and the center of the volume area occupied by the beacon are identical and that the spatial orientations are identical (e.g. parallel surfaces can be found for the beacon and the geometric form of the virtual sensor).

The position of the beacon computed at step 206 is used to determine the position in the scene of the virtual sensor, i.e. to determine the position in the real scene 151 of the virtual sensor volume area. More precisely, the volume area of the virtual sensor is defined with respect to the position of the beacon computed at step 206. The position of the virtual sensor volume area with respect to the beacon may be defined in various ways. In one or more embodiments, the position in the scene of the virtual sensor volume area is determined in such a way that the position of the beacon falls within the virtual sensor volume area. For example, the position of the beacon may correspond to a predefined point of the virtual sensor volume area, for example the center of the virtual sensor volume area, the center of an upper/lower surface of the volume area, or to any other point whose position is defined with respect to the geometric form of the virtual sensor volume area. In one or more embodiments, the virtual sensor volume area does not include the position of the beacon, but is positioned at a predefined distance from the beacon. For example, the virtual sensor volume area may be above the beacon, in front of the beacon, or below or above the beacon, for example at a given distance. For example, when the beacon is a picture on a wall, the virtual sensor volume area may be defined by a parallelepipedic volume area in front of the picture, with a first side of parallelepipedic volume area be closed to the picture and having similar size and geometric form and be parallel to the wall and the picture, i.e. having the same spatial orientation.

In one or more embodiments, the determination of the volume area of the virtual sensor comprises determining the position of the beacon 150A in the scene using the 3D representation 114 of the scene. The use of a beacon 150A for positioning the volume area of a virtual sensor may simplify such positioning, or a re-positioning of an already defined virtual sensor volume area, in particular when the sensors 103 comprise a 3D camera capable of capturing a 3D images of the scene comprising the beacon 150A. In addition, the size and/or geometric form of virtual sensor volume area may be different from the size and/or geometric form of the beacon used for defining the position in the scene of the virtual sensor thus providing a large number of possibilities for using beacons of any type and any size for configuring virtual sensors.

In one or more embodiments, the beacon is a specific part of the body of a user, and the generation of the virtual sensor configuration data for the virtual sensor comprises: determining from a plurality of temporally successive 3D representations that the specific part of the body performs a predefined gesture and/or motion and generating the virtual sensor configuration data for the virtual sensor corresponding to the predefined gesture. The position of the beacon computed at step 206 may correspond to a position in the real scene of the specific part of the body at the time the predefined gesture and/or motion has been performed.

A given gesture may be associated with a given sensor type and corresponding virtual sensor configuration data may be recorded at step 208 upon detection of this given gesture/motion. Further, the position in the scene of the part of the body, at the time the gesture/motion is performed in the real scene, corresponds to the position determined for the beacon. Similarly, the size and/or geometric form of virtual sensor volume area may be determined on the basis of the path followed by the part of the body performing the gesture/motion and/or on the basis of the volume area occupied by the part of the body while the part of the body performs the gesture/motion.

For example, for defining a beacon used as a virtual barrier, a user may perform a gesture/motion (e.g. hand gesture) that outlines the volume area of the virtual barrier, at the position in the scene corresponding to the position of the virtual barrier. For example, for defining a beacon used as a virtual button, a user may perform with his hand a gesture/motion that mimics the gesture of a user pushing with his index on a real button at the position in the scene corresponding to the position of the virtual button. For example, for defining a beacon used as a virtual slider, a user may perform with his hand a gesture/motion (vertical 1 horizontal motion) that mimics the gesture of a user adjusting the value of a real slider at the position in the scene corresponding to the position of the virtual button.

FIG. 1 illustrates the example situation where a beacon 150A is used to determine the position of a virtual sensor 170A, a beacon 150B is used to determine the position of a virtual sensor 1708, and a beacon 1500 is used to determine the position of a virtual sensor 1700. In the exemplary embodiment illustrated by FIG. 1, the beacon 150A (respectively 150B, 150C) is located in the volume area of an associated virtual sensor 170A (respectively 170B, 170C). As illustrated by FIG. 1, the size and shape of a beacon used to define a virtual sensor need not to be the same as the size and shape of the virtual sensor volume area, while the position of the beacon is used to determine the position in the scene of the virtual sensor volume area.

For example, the beacon 150A (the picture 150A in FIG. 1) is used to define the position of a virtual sensor 170A whose volume area has the same size and shape as the picture 1501. For example, the beacon 150B (the parallelepipedic object 150B on the table 153 in FIG. 1) is used to define the position of a virtual sensor 170B whose volume area has the same parallelepipedic shape as the parallelepipedic object 150B but a different size than the parallelepipedic object 150B used as beacon. The virtual sensor 170B may for example be used as a barrier for detecting that someone is entering or exiting the scene 151 through the door 155. For example, the beacon 150C (the cylindrical object 150C in FIG. 1) is used to define the position of a virtual sensor 170C whose volume area has a different shape (i.e. a parallelepipedic shape in FIG.1) and different size than the cylindrical object 150C used as beacon.

The size and/or shape of a beacon may be chosen so as to facilitate the detection of the beacon in the real scene and/or to provide some mnemonic means for a user using several beacons to remember which beacon is associated with which predefined virtual sensor and/or with which predefined virtual sensor configuration data set.

In one or more embodiments, the virtual sensor configuration data 115 are determined on the basis at least of the position of the beacon computed at step 206 and, optionally, of the additional configuration data transmitted at step 207. For example, predefined virtual sensor configuration data associated with the configuration identification data configuration data transmitted by the data signal are obtained from the repository 110, 161. The determination of the virtual sensor configuration data 115 includes the determination of a virtual sensor volume area, at least one virtual sensor trigger condition and/or at least one associated operation,

In one or more embodiments, a feedback may be provided to a user through the user interface 118. For example, the virtual sensor configuration data 115, and/or the additional configuration data transmitted at step 207, may be displayed on a display screen 118. For example, a feedback signal (a sound signal, luminous signal, vibration signal . . . ) is emitted to confirm that a virtual sensor has been detected in the scene. The feedback signal may further include coded information on the determined virtual sensor configuration data 115. For example, the geometric form of the virtual sensor volume area, the size of the virtual sensor volume area, one or more virtual sensor trigger conditions, and one or more associated operations to be triggered when a virtual sensor trigger condition is fulfilled may be coded into the feedback signal.

In one or more embodiments, the determination of the volume area of a virtual sensor comprises selecting a predefined geometric shape and size. Examples of predefined geometric shapes include, but are not limited to, square shape, rectangular shape, or any polygon shape, disk shape, cubical shape, rectangular solid shape, parallelepiped rectangle or any polyhedron shape, and spherical shape. Examples of predefined sizes may include, but are not limited to, 1 cm (centimeter), 2 cm, 5 cm, 10 cm, 15 cm, 20, cm, 25 cm, 30 cm, 50 cm. The size may refer to the maximal dimension (width, height or depth) of the shape. Such predefined geometric shapes and sizes are parameters whose values are input to the virtual sensor engine 106,

For example, the additional configuration data may represent value(s) of one or more configuration parameters of the following list: a geometric form of the virtual sensor volume area, a size of the virtual sensor volume area, one or more virtual sensor trigger conditions, and one or more associated operations to be triggered when a virtual sensor trigger condition is fulfilled.

In one or more embodiments, the additional configuration data comprise a configuration data set identifier that identifies a predefined virtual sensor configuration data set. The geometric form, size, trigger condition(s) and associated operation(s) of virtual sensor configuration data 115 may thus be determined on the basis of the identified predefined virtual sensor configuration data set.

In one or more embodiments, the additional configuration data comprise a virtual sensor type from a list of virtual sensor types. The geometric form, size, trigger condition(s) and associated operation(s) of virtual sensor configuration data 115 may thus be determined on the basis of the identified virtual sensor type and of a predefined virtual sensor configuration data set associated with this the identified virtual sensor type.

In one or more embodiments, the additional configuration data comprise an operation identifier that identifies one or more associated operations to be triggered when a virtual sensor trigger condition is fulfilled. The one or more associated operations may thus be determined on the basis of the identified operation.

In one or more embodiments, the definition of virtual sensor configuration data 115 may performed by a user and/or on the basis of the additional configuration data transmitted at step 207 by means of a user interface 118. For example, the value of the geometric form, size, trigger condition(s) and associated operation(s) may be selected and/or entered and/or edited by a user through a user interface 118.

For example, a user may manually amend the predefined virtual sensor configuration data 115 through a graphical user interface displayed on a display screen of the user interface 118, for example by adjusting the size and/or shape of the virtual sensor volume area, updating the virtual sensor trigger condition and/or adding, modifying or deleting one or more associated operations to be triggered when a virtual sensor trigger condition is fulfilled.

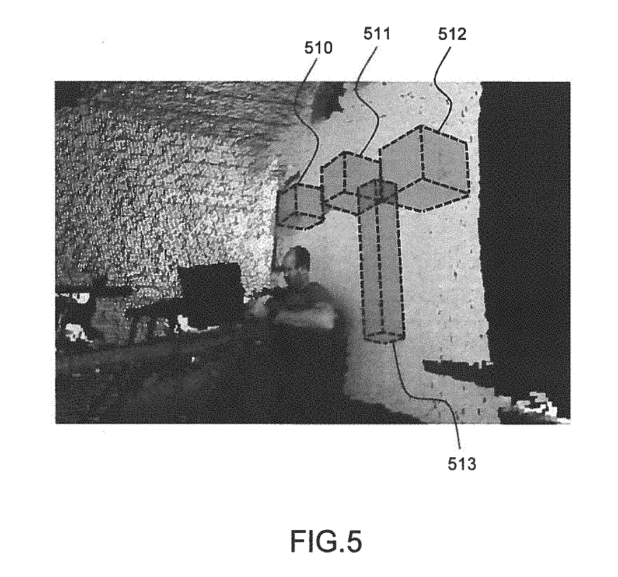

In one or more embodiments, the virtual sensor sub-system 102 may be configured to provide a visual feedback to a user through a user interface 118, for example, by displaying on a display screen 118 an image of the 3D representation 114. In one or more embodiments, the displayed image may include a representation of the volume area of the virtual sensor, which may be used for purposes of defining and configuring 301 a virtual sensor in the scene. FIG. 5 is an example of a 3D image of a 3D representation from which the position of the beacons 510, 511, 512, 513 have been detected. The 3D image includes a 3D representation of the volume area of four virtual sensors 510, 511, 512, 513. A user of the virtual sensor sub-system 102 may thus verify on the 3D image that the virtual sensors 510, 511, 512, 513 are correctly located in the real scene and may change the position of the beacons in the scene. There is therefore no need for a user interface to navigate into a 3D representation.

In one or more embodiments, the virtual sensor configuration data 115 may be stored in a configuration file or in the repository 110, 161 and are used as input configuration data by the virtual sensor engine 106. The virtual sensor configuration data 115 may be stored in association with a virtual sensor identifier, a virtual sensor type identifier and/or a configuration data set identifier. The virtual sensor configuration data 115 may be stored in the local repository 110 or in the remote repository 161.

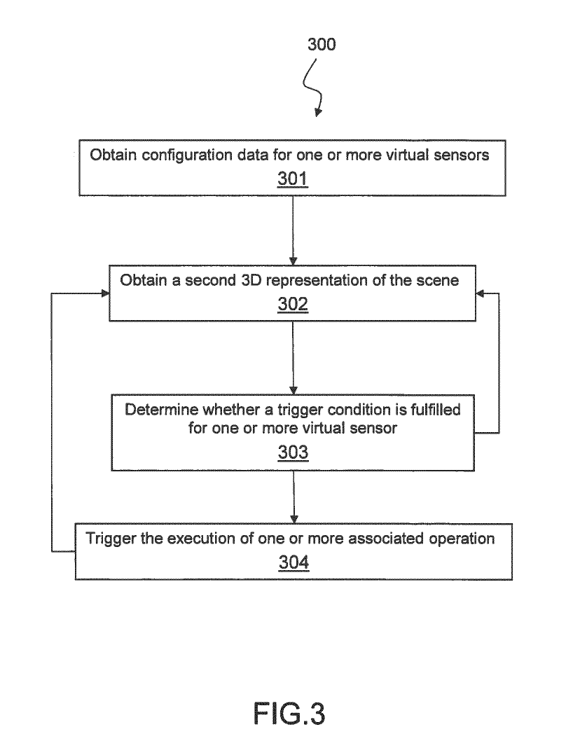

Referring now to FIG. 3, a method 300 for detecting activation of a virtual sensor may be implemented using the exemplary virtual sensor system 100 described above, which includes the scene capture sub-system 101 and the virtual sensor sub-system 102. In the following reference will be made to components of the virtual sensor system 100 described with respect to FIG. 1. The method 300 may be executed by the virtual sensor sub-system 102, for example by the virtual sensor engine 106 and the command engine 107.

In step 301, virtual sensor configuration data 115 are obtained for one or more virtual sensors.

In step 302, a second 3D representation 114 of the real scene is generated by the scene capture subsystem 101. In one or more embodiments, one or more captured representations of the scene is generated by the scene capture sub-system 101 and a second 3D representation 114 of the real scene is generated on the basis of the one or more captured representations. The second 3D representation is for example generated by the scene capture sub-system 101 according to any process described and or using any technology described therein. Like the first 3D representation, the second 3D representation comprises points representing objects in the real scene and respective associated positions in the real scene. The second 3D representation comprises points representing surfaces of objects, i.e. non-empty areas, detected by the sensors 103 of the scene capture sub-system 101.

In one or more embodiments, the second 3D representation comprises point cloud data, the point cloud data comprising positions in the real scene and respective associated points representing objects in the scene. The point cloud data represents surfaces of objects in the scene. The first 3D representation may be a 3D image representing the scene. A position of a point of an object in the scene may be represented by a 3D coordinates with respect to a predetermined origin. The predetermined origin may for example be a 3D camera in the case where the scene is captured by a sensor 103 which is a 3D image sensor (e.g. a 3D camera). In one or more embodiments, data for each point of the point cloud may include, in addition to the 3D coordinate data, other data such as color data, intensity data, noise data, etc.

The steps 303 and 304 may be executed for each virtual sensor for which configuration data are available for the captured scene 151.

In step 303, the second 3D representation of the scene is analyzed in order to determine whether a triggering condition for one or more virtual sensors is fulfilled. For each defined virtual sensor, the determination is made on the basis of a portion of the second 3D representation scene corresponding to the volume area of the virtual sensor. For a same virtual sensor, one or more associated operations may be triggered. For each associated operation, one or more virtual sensor trigger conditions to be fulfilled for triggering the associated operation may be defined.

In one or more embodiments, a virtual sensor trigger condition may be defined by one or more minimum thresholds and optionally by one or more maximum threshold. Specifically, a virtual sensor trigger condition may be defined by a value range, i.e. a couple including a minimum threshold and a maximum threshold. When different value ranges are defined for a same virtual sensor, each value range may be associated with a different action so as to be able to trigger one of plurality of associated operations depending upon the size of the object that enters in the volume area of the virtual sensor.

The determination that the triggering condition is fulfilled comprises counting the number of points of the 3D representation 114 that falls within the volume area of the virtual sensor and determining whether this number of points fulfills one or more virtual sensor trigger conditions.

In one or more embodiments, a minimum threshold corresponds to a minimal number of points of the 3D representation 114 that falls within the volume area of the virtual sensor. When this number is above the threshold, the triggering condition is fulfilled, and not fulfilled otherwise.

In one or more embodiments, a maximum threshold corresponds to a maximal number of points of the 3D representation 114 that falls within the volume area of the virtual sensor. When this number is below the maximum threshold, the triggering condition is fulfilled, and not fulfilled otherwise.

When the triggering condition is fulfilled for a given virtual sensor, step 304 is executed. Otherwise step 303 may be executed for another virtual sensor.

The analysis 303 of the 3D representation 114 may thus comprise determining a number of points in the 3D representation whose position falls within the volume area of a virtual sensor. This determination may involve testing each point represented by the 3D representation 114, and checking that whether the point under test is located inside the volume area of a virtual sensor. Once the number of points located inside the virtual sensor area is determined, it is compared to the triggering threshold. If the determined number is greater or equal to the triggering threshold, the triggering condition of the virtual sensor is considered fulfilled. Otherwise the triggering condition of the virtual sensor is considered not fulfilled.

Optionally, this threshold corresponds to a minimal number of points of the 3D representation 114 that fall within the volume area of the virtual sensor and that fulfill an additional condition. The additional condition may be related to the intensity, color, reflectivity or any other property of a point in the 3D representation 114 that fall within the volume area of the virtual sensor. The determination that the triggering condition is fulfilled comprises counting the number of points of the 3D representation 114 that fall within the volume area of the virtual sensor and that fulfill this additional condition. When this number is above the threshold, the triggering condition is fulfilled, and not fulfilled otherwise,

For example, the triggering condition may specify a certain amount of intensity beyond which the triggering condition of the virtual sensor will be considered fulfilled. In such case, the analysis 303 of the 3D representation 114 determining an amount of intensity (e.g. average intensity) of points of the 3D representation 114 that fall within the volume area of a virtual sensor. Once the amount of intensity is determined, it is compared to the triggering intensity threshold. If the determined amount of intensity is greater or equal to the triggering threshold, the triggering condition of the virtual sensor is considered fulfilled. Otherwise the triggering condition of the virtual sensor is considered not fulfilled. The intensity refers herewith to the intensity of a given physical characteristic defined in relation with the sensor of the scene capture sub-system. For example, in the case of a sound based scene capture sub-system, the triggering condition may be fulfilled when the intensity of sound of the points located in the virtual sensor's volume area exceeds a given threshold. Other physical characteristics may be used, as for example the temperature of the points located in the virtual sensor's volume area, the reflectivity, etc.

In step 304, in response to the determination that a virtual sensor trigger condition is fulfilled, the execution of one or more associated operation is triggered. The execution of the operation may be triggered by the computing device 105, for example by the command engine 107 or by another device to which the computing device 105 is operatively connected.

Steps 303 and 304 may be executed and repeated for each 3D representation received by the virtual sensor sub-system 102.

In one or more embodiments, one or more steps of the method for configuring the virtual sensor described herein, for example by reference to FIG. 1 and/or 2, may be triggered upon receipt of an activation command by the virtual sensor sub-system 102. Upon receipt of the activation command, the virtual sensor sub-system 102 enters in configuration mode in which one or more steps of a method for configuring the virtual sensor described herein are implemented and the virtual sensor sub-system 102 implements processing steps for detecting the presence of a beacon in the scene, for example step 206 as described by reference to FIG. 2. Once a virtual sensor has been configured, the virtual sensor sub-system 102 may automatically enters in sensor mode in which the detection of the activation of a virtual sensor is implemented using one or more steps of a method for detecting activation of a virtual sensor described herein, for example by reference to FIGS. 1 and/or 3.

The activation command may be a command in any form: for example a radio command, an electric command, a software command, but also a voice command, a sound command, a specific gesture of a part of the body of a person/animal/robot, a specific motion of a person/animal/robot/object, etc. The activation command may be produced by a person/animal/robot (e.g. voice command, specific gesture, specific motion) or be sent to the virtual sensor sub-system 102 when a button is pressed on a beacon or on the computing device 105, when a user interface item is activated on a user interface of the virtual sensor sub-system 102, when a new object is detected in a 3D representation of the scene, etc.

In one or more embodiments, the activation command may be a gesture performed by a part of the body of a user (e.g. a person/animal/robot) and the beacon itself is also this part of the body. In one or more embodiments, the activation of the configuration mode as well as the generation of the virtual sensor configuration data may be performed on the basis of a same gesture and/or motion of this part of the body.

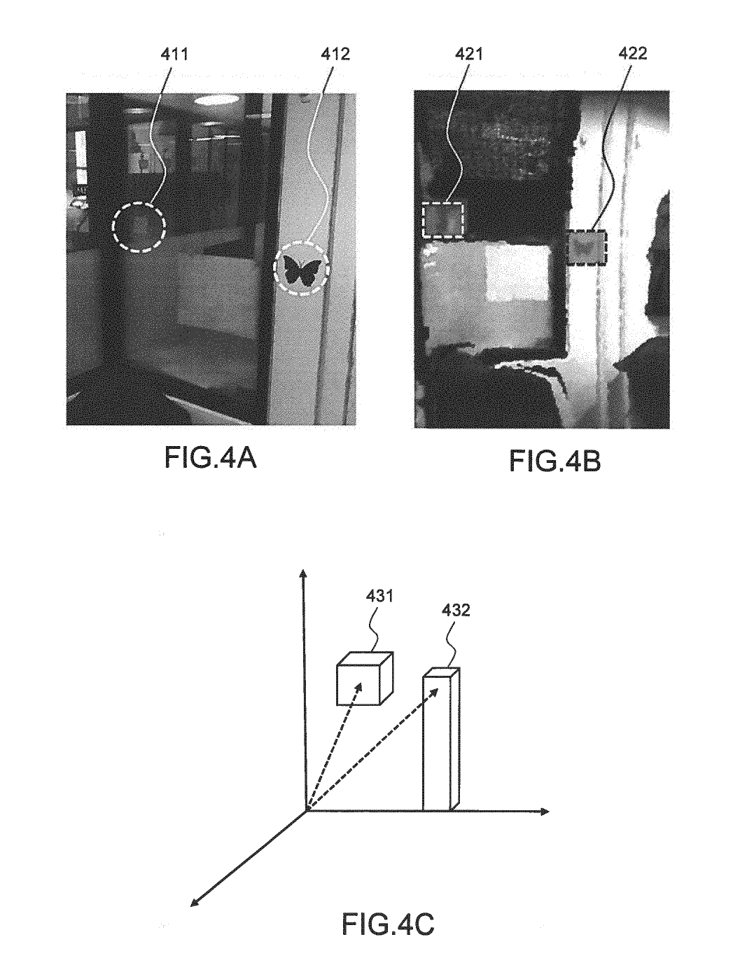

FIGS. 4A-4C show beacon examples in accordance with one or more embodiments. FIG. 4A is a photo of a real scene in which a post-it 411 (first beacon 411) has been stick on a window and a picture 412 of a butterfly (second beacon 412) has been placed on a wall. FIG. 4B is a 3D representation of the real scene from which the position of the beacons 411 and 412 have been detected and in which two corresponding virtual sensors 421 and 422 are represented at the position of the detected beacons 411 and 412 of FIG. 4A. FIG. 4C is a graphical representation of two virtual sensors 431 and 432 placed in the real scene at the positions of the detected beacons 411 and 412, wherein the volume area of virtual sensor 431 (respectively 432) is different from the volume and/or size of the associated beacon 411 (respectively 422).

The examples of FIGS. 4A to 4C the beacons are always present in the scene. In one or more embodiments, the beacons may only be present for calibration and set-up purposes, i.e. for the generation of the virtual sensor configuration data and the beacons may be removed from the scene afterwards.

FIGS. 4A-4C illustrates the flexibility with which virtual sensors can be defined and positioned. Virtual sensors can indeed be positioned anywhere in a given sensing volume, independently from structures and surfaces of objects in the captured scene 151. The disclosed virtual sensor technology allows defining a virtual sensor with respect to a real scene, without the help of any preliminary 3D representation of a scene as the position of a virtual sensor is determined from the position in the real scene of a real object used as a beacon to mark a position in the scene.

While the invention has been described with respect to preferred embodiments, those skilled in the art will readily appreciate that various changes and/or modifications can be made to the invention without departing from the spirit or scope of the invention as defined by the appended claims. In particular, the invention is not limited to specific embodiments regarding the virtual sensor systems and may be implemented using various architecture or components thereof without departing from its spirit or scope as defined by the appended claims.

Although this invention has been disclosed in the context of certain preferred embodiments, it should be understood that certain advantages, features and aspects of the systems, devices, and methods may be realized in a variety of other embodiments. Additionally, it is contemplated that various aspects and features described herein can be practiced separately, combined together, or substituted for one another, and that a variety of combination and subcombinations of the features and aspects can be made and still fall within the scope of the invention. Furthermore, the systems and devices described above need not include all of the modules and functions described in the preferred embodiments.

Information and signals described herein can be represented using any of a variety of different technologies and techniques. For example, data, instructions, commands, information, signals, bits, symbols, and chips can be represented by voltages, currents, electromagnetic waves, magnetic fields or particles, optical fields or particles, or any combination thereof.

Depending on the embodiment, certain acts, events, or functions of any of the methods described herein can be performed in a different sequence, may be added, merged, or left out all together (e.g., not all described acts or events are necessary for the practice of the method). Moreover, in certain embodiments, acts or events may be performed concurrently rather than sequentially.

1. A method for configuring a virtual sensor in a real scene, the method comprising:
obtaining at least one first three dimensional (3D) representation of the real scene, wherein said at least one first 3D representation comprises points representing objects in the real scene and respective associated positions in the real scene;
analyzing said at least one first 3D representation to detect a beacon in the real scene, and computing a position of the beacon in the real scene from at least one position associated to a least one point of a set of points representing the beacon in said at least one first 3D representation;
generating virtual sensor configuration data for the virtual sensor on the basis at least of the position of the beacon, the virtual sensor configuration data representing:
a volume area having a predefined positioning, with respect to the beacon;
at least one virtual sensor trigger condition associated with the volume area, and
at least one operation to be triggered when said at least one virtual sensor trigger condition is fulfilled.

2. The method according to claim 1, wherein analyzing said at least one first 3D representation to detect a beacon in the real scene comprises:
obtaining beacon description data that specifies at least one identification element of the beacon and
executing a processing function to detect points of the 3D representation that represents an object having said identification element.

3. The method according to claim 1, wherein analyzing said at least one 3D representation to detect a beacon in the real scene comprises:
obtaining beacon description data that specifies at least one property of the beacon and
executing a processing function to detect points of said at least one 3D representation that represents an object having said property.

4. The method according to claim 1, wherein the beacon comprises an emitter for emitting at least one optical signal, wherein the position of the beacon in the real scene is determined from at least one position associated to a least one point of a set of points representing an origin of the optical signal.

5. The method according to claim 1, wherein the beacon comprises at least one identification element, wherein the position of the beacon in the real scene is determined from at least one position associated to a least one point of a set of points representing said identification element.

6. The method according to claim 5, wherein said at least one identification element comprises at least one element from the group consisting of a reflective surface, a surface with a predefined pattern, an element having a predefined shape, an element having a predefined color, an element having a predefined size, an element having predefined reflective properties.

7. The method according to claim 1, wherein the beacon has a predefined property, wherein the position of the beacon in the real scene is determined from at least one position associated to a least one point of a set of points representing the beacon with the predefined property.

8. The method according to claim 1, further comprising.
obtaining at least one second 3D representation of the real scene,
making a determination from a portion of said at least one second 3D representation of the real scene that falls into the volume area of the virtual sensor that said at least one virtual sensor trigger condition is fulfilled;
triggering an execution of said at least one operation upon determination that said at least one virtual sensor trigger condition is fulfilled.

9. The method according to claim 1, further comprising detecting at least one data signal coming from the beacon, wherein the data signal encodes additional configuration data, wherein the virtual sensor configuration data are generated on the basis of the additional configuration data.

10. A method according to claim 9, wherein said at least one data signal is emitted by the beacon upon activation of an actuator of the beacon.

11. A method according to claim 9, further comprising:
emitting a source signal towards the beacon,
wherein said at least one data signal comprise at least one response signal produced by the beacon in response to the receipt of the source signal.

12. A method according to claim 9, wherein said at least one data signal comprises several elementary signals and wherein the generation of virtual sensor configuration data is performed in dependence upon a number of elementary signals in said at least one data signal or a rate at which said elementary signals are emitted.

13. The method according to claim 9, wherein the method further comprises determining a virtual sensor type from a set of predefined virtual sensor types on the basis of said additional configuration data, wherein the virtual sensor configuration data are generated on the basis of predefined virtual sensor configuration data stored in association with the virtual sensor type.

14. The method according to claim 9, wherein the method further comprises identifying in a repository a predefined virtual sensor configuration data set on the basis of said additional configuration data.

15. The method according to claim 14, further comprising,
storing in a repository the predefined virtual sensor configuration data set in association with a configuration data set identifier, wherein the predefined virtual sensor configuration data comprise at least one predefined volume area, at least one predefined trigger condition and at least one predefined operation,
extracting the configuration data set identifier from the additional configuration data,
retrieving, on the basis of the extracted configuration data set identifier, the predefined virtual sensor configuration data set stored in the repository,
generating the virtual sensor configuration data from the retrieved predefined virtual sensor configuration data set.

16. The method according to claim 1, wherein the beacon is a part of the body of a user, wherein generating said virtual sensor configuration data for the virtual sensor comprises:
determining from said at least one first 3D representation that said part of the body performs a predefined gesture/motion;
generating virtual sensor configuration data for the virtual sensor corresponding to the predefined gesture, wherein the position of the virtual sensor corresponds to a position in the real scene of said part of the body at the time the predefined gesture motion has been performed.

17. A system for configuring a virtual sensor in a real scene, the system comprising:
a configuration sub-system for
obtaining a first three dimensional (3D) representation, wherein the 3D representation comprises points representing objects in the real scene and respective associated positions in the real scene;
analyzing said 3D representation to detect a beacon in the real scene, and computing a position of the beacon in the real scene from at least one position associated to a least one point of a set of points representing the beacon in said 3D representation,
generating virtual sensor configuration data for the virtual sensor on the basis at least of the position of the beacon, the virtual sensor configuration data representing: a volume area having a predefined positioning with respect to the beacon, at least one trigger condition associated with the volume area, and at least one operation to be triggered when said at least one trigger condition is fulfilled.

18. A beacon of a system for configuring a virtual sensor in a real scene,
wherein the beacon is configured to be placed in the real scene so as to mark a position in the real scene;
wherein the system comprises a configuration sub-system for
obtaining a first three dimensional (3D) representation of the real scene, wherein the 3D representation comprises points representing objects in the real scene and respective associated positions in the real scene;
analyzing said 3D representation to detect a beacon in the real scene, and computing a position of the beacon in the real scene from at least one position associated to a least one point of a set of points representing the beacon in said 3D representation,
generating virtual sensor configuration data for the virtual sensor on the basis at least of the position of the beacon, the virtual sensor configuration data representing a volume area having a predefined positioning with respect to the beacon, at least one trigger condition associated with the volume area, and at least one operation to be triggered when said at least one trigger condition is fulfilled.
wherein the beacon comprises at least one identification element, wherein the position of the beacon in the real scene is determined from at least one position associated to a least one point of a set of points representing said identification element in the first 3D representation.

19. A beacon of a system for configuring a virtual sensor in a real scene,
wherein the beacon is configured to be placed in the real scene so as to mark a position in the real scene,
wherein the system comprises a configuration sub-system for
obtaining a first three dimensional (3D) representation of the real scene, wherein the 3D representation comprises points representing objects in the real scene and respective associated positions in the real scene;
analyzing said 3D representation to detect a beacon in the real scene, and computing a position of the beacon in the real scene from at least one position associated to a least one point of a set of points representing the beacon in said 3D representation,
generating virtual sensor configuration data for the virtual sensor on the basis at least of the position of the beacon, the virtual sensor configuration data representing a volume area having a predefined positioning with respect to the beacon, at least one trigger condition associated with the volume area, and at least one operation to be triggered when said at least one trigger condition is fulfilled.
wherein the beacon comprises an emitter for emitting a signal, wherein the position of the beacon in the real scene is determined from at least one position associated to a least one point of a set of points representing an origin of the signal in the first 3D representation.

20. A beacon of a system for configuring a virtual sensor in a real scene,
wherein the beacon is configured to be placed in the real scene so as to mark a position in the real scene,
wherein the system comprises a configuration sub-system for
obtaining a first three dimensional (3D) representation of the real scene, wherein the 3D representation comprises points representing objects in the real scene and respective associated positions in the real scene;
analyzing said 3D representation to detect a beacon in the real scene, and computing a position of the beacon in the real scene from at least one position associated to a least one point of a set of points representing the beacon in said 3D representation,
generating virtual sensor configuration data for the virtual sensor on the basis at least of the position of the beacon, the virtual sensor configuration data representing: a volume area having a predefined positioning with respect to the beacon, at least one trigger condition associated with the volume area, and at least one operation to be triggered when said at least one trigger condition is fulfilled.
wherein the beacon has a predefined property, wherein the position of the beacon in the real scene is determined from at least one position associated to a least one point of a set of points representing the beacon with the predefined property in the first 3D representation.
